(19) United States
(12) Patent Application Publication
(10) Pub. No.: US 2019/0202953 A1
(43) Pub. Date: Jul. 4, 2019

(54) POLYMERIZING COMPOSITION, METHOD OF MANUFACTURE THEREOF AND ARTICLES COMPRISING THE SAME

(71) Applicant: THE UNIVERSITY OF MASSACHUSETTS, Boston, MA (US)

(72) Inventors: Alan James LESSER, Shutesbury, MA (US); Matthew LAMPE, Amherst, MA (US)

(21) Appl. No.: 16/327,541

(22) PCT Filed: Aug. 23, 2017
(86) PCT No.: PCT/US2017/048185

§ 371 Date: Feb. 22, 2019

Related U.S. Application Data
(60) Provisional application No. 62/378,335, filed on Aug. 23, 2016.

(51) Int. Cl. C08F 220/18; C08G 59/22; C08L 63/00; C08L 33/06; C08F 222/10; C08K 5/00; C08K 5/5397; C08F 2/48; C08K 5/053; C08K 5/06

(52) U.S. Cl. CPC C08F 220/18; C08G 59/226; C08L 63/00; C08L 33/06; C08F 222/1006; C08F 2222/1026; C08K 5/5397; C08F 2/48; C08K 5/053; C08K 5/06; C08F 2800/20; C08K 5/0025

(57) ABSTRACT

Disclosed herein is a composition comprising a first low molecular weight molecule that is radically polymerizable; a second low molecular weight molecule that is ionically polymerizable; and an initiator package that comprises a free radical initiator, an ionic accelerator and an ionic initiator; where the first low molecular weight molecule undergoes a radical polymerization reaction when subjected to a first form of activation stimuli and where the second low molecular weight molecule undergoes an ionic polymerization reaction in a spatially propagating reaction front or in a global reaction that occurs throughout the entire composition; where the ionic polymerization is initiated by a second form of activation stimuli.

### BACKGROUND

Disclosed herein is a polymerizing composition, methods of manufacture thereof and articles comprising the same.

Frontal polymerization is a process in which the polymerization propagates through a reactant medium typically in a reaction vessel. There are three types of frontal polymerizations—thermal frontal polymerization (TFP), which uses an external energy source to initiate the front, photofrontal polymerization in which the localized reaction is driven by an external ultraviolet (UV) source, and isothermal frontal polymerization (IFP), which relies on the Norrish-Trommsdorff, or gel effect, that occurs when a monomer and an initiator diffuse into a polymer seed (e.g., a small piece of polymer).

Thermal frontal polymerizations typically begin when a heat source contacts a solution of monomer and thermal initiator. Alternatively, a UV source can be applied if a photoinitiator is also present. The area of contact (or UV exposure) has a faster polymerization rate, and the energy from the exothermic polymerization diffuses into the adjacent region, raising the temperature and increasing the reaction rate at that location. The result is a localized reaction zone that propagates down the reaction vessel as a thermal wave.

Most frontal polymerizations take place in liquid systems (i.e. systems that are in the form of fluids at the polymerizing temperature), and most of these liquid systems consist of relatively thin layers. There are some notable exceptions when frontal polymerization has been used to create monolithic shapes, but if these are done with a liquid systems then they are not typically freestanding and therefore use a mold to create the desired final shape.

One exception to the liquid system is the creation of a thin film of a mixture of epoxy and acrylate functional monomers. The acrylate portion of this film is then cured into a gel using broad spectrum UV light. The broad spectrum UV light allows for the activation of the cation generator in the epoxy. This activated epoxy gel can then be frontally polymerized, but only within the timespan of a very limited activation life. Additionally, the film has to be thin because the heat of the curing acrylate can actually initiate the frontal polymerization of the excited epoxy system if the sample is too thick.

Another exception to a purely liquid system is one in which a gel is formed by the combination of reactants under low-temperature conditions. These temperature conditions allow for the gel to form without the subsequent frontal polymerization being initiated. The frontal polymerization is then initiated by application of a secondary gel and UV radiation. In none of these references is a room temperature liquid system that can undergo separate gelation, where a storable stable gel is formed, followed by a frontal polymerization at the desired time.

It is therefore desirable to have a stable gel, which can be stored for an extended period of time and where the reactive monomers are in their final shape prior to polymerization of the second network.

### SUMMARY

Disclosed herein is a composition comprising a first low molecular weight molecule that is radically polymerizable; a second low molecular weight molecule that is ionically polymerizable; and an initiator package that comprises a free radical initiator, an ionic accelerator and an ionic initiator; where the first low molecular weight molecule undergoes a radical polymerization reaction when subjected to a first form of activation stimuli and where the second low molecular weight molecule undergoes an ionic polymerization reaction in a spatially propagating reaction front or in a global reaction that occurs throughout the entire composition; where the ionic polymerization is initiated by a second form of activation stimuli.

Disclosed herein too is a method of manufacturing an article comprising mixing together a composition comprising a first low molecular weight molecule that is radically polymerizable; a second low molecular weight molecule that is ionically polymerizable; and an initiator package that comprises a free radical initiator, an ionic accelerator and an ionic initiator; subjecting the first low molecular weight molecule to a first form of activation stimuli; polymerizing the first low molecular weight molecule via radical polymerization in a first polymerization reaction; subjecting the second low molecular weight molecule to a second form of activation stimuli; and polymerizing the second low molecular weight molecule via ionic polymerization in a second polymerization reaction.

### BRIEF DESCRIPTION OF THE FIGURES

FIG. 1 is a depiction of the proposed mechanism for the frontal polymerization of epoxy, showing both thermal and UV initiation;

FIG. 2 shows the storage and loss modulus plotted against time at 10 radians/second for 24 hours in a gelled sample; and

FIG. 3 is a graph showing viscosity measurements for both a new sample (the second sample) and a sample that had aged for 502 days (the first sample).

### DETAILED DESCRIPTION

Disclosed herein is a composition for an ionically frontal polymerizing system that contains two or more reactive species in a reaction mixture. In a preferred embodiment, the two or more reactive species can react sequentially. The composition comprises two or more reactive species with an initiator package that comprises two or more initiators and a radical generator. In an exemplary embodiment, the respective reactants are polymerized sequentially using different stimuli (different forms of activation) to effect the polymerization. The polymerization results in two networks—a first polymeric network and a second polymeric network that are formed without significant interaction or interference during the polymerization. In other words, during the formation of the first polymeric network, the ingredients that are used to form the second polymeric network are not substantially consumed, utilized or converted. In an embodiment, the first polymerization reaction does not restrict or interact with the reactants for the second polymerization reaction, though if desired the second polymerization reaction can interact with the components or products of the first polymerization reaction.

Disclosed herein too is a method for manufacturing articles from a composition for a frontally polymerizing system that contains two or more reactive species. The method involves mixing the two or more reactive species with an initiator package that comprises two or more initiators and reacting the respective reactants using different stimuli. The use of two different reactive species that react under differing conditions permits the manufacture of articles by additive manufacturing or 3D printing where a plurality of layers can be disposed on a substrate and where each layer is first reacted using a first stimuli (e.g., ultraviolet (UV) radiation) and then bonded together (i.e., the plurality of layers are bonded together) using a second stimuli (e.g., thermal energy).

In an embodiment, the composition comprises a dimensionally stable reaction mixture having two or more reactive species that can undergo at least two simultaneous or sequential polymerization reactions while in the reaction mixture—a first polymerization reaction where a first portion of the reactive mixture is reacted under a first stimulus (hereinafter activator), and a second polymerization reaction where a spatially propagating reaction front is initiated by a second activator and where the spatially propagating front promotes an additional reaction that reacts an additional amount of at least one of the reactants in the reaction mixture. In another embodiment, the composition is also shelf stable—i.e., it can be stored for long periods of time (e.g., at room temperature or below in the preferred absence of UV radiation) such as, for example, periods greater than 6 days, preferably greater than 14 days, preferably greater than 1 month, without appreciable changes in composition or in viscosity. Even though there may be changes in viscosity after a period of two weeks to 1 month, the composition can still be applied to a desired substrate and polymerized.

In an embodiment, the composition for the frontally polymerizing system comprises two or more different low molecular weight molecules (e.g., monomers, dimers, trimers, and the like, and/or oligomers)—a first low molecular weight molecule and a second low molecular weight molecule. One of the low molecular weight molecules can undergo free radical polymerization while the other undergoes ionic polymerization. Ionic polymerization may include cationic and/or anionic polymerization. In an embodiment, the first low molecular weight molecule is radically polymerizable, while the second low molecular weight molecule is cationically polymerizable. Because of the stability of the composition, the second reaction can be conducted at least 1 day after the first reaction, preferably at least 7 days after the first reaction, and more preferably at least 14 days after the first reaction.

The composition is generally more stable when protected from UV radiation after the first polymerization reaction is completed. After the first polymerization reaction is completed, the composition is in the form of a thermally stable gel. The first polymerization reaction results in the gelation of the composition to produce the thermally stable gel. A thermally stable gel is one that is stable (does not change in viscosity or composition) at a temperature of 30° C. or less, preferably room temperature (25° C.) or less. The second polymerization reaction can be conducted at a later time to facilitate crosslinking of the second low molecular weight molecule to produce a second polymer network. Stability can also be construed to include that the second reaction is not substantially triggered (initiated) during storage at 30° C. or less, preferably room temperature or less.

Disclosed herein too is a reaction product of the composition after the first polymerization reaction. The reaction product comprises a first crosslinked polymer and a second low molecular weight molecule that is as yet unreacted and that is ionically polymerizable. The second low molecular weight molecule can be reacted by using a second form of activation stimuli to form a reaction product that comprises two crosslinked networks—a first network and a second network. The second low molecular weight molecule can be reacted 24 hours or more after the first crosslinked polymer is formed.

The composition further contains an initiator blend that contains two or more initiators namely a first initiator that comprises at least one free radical initiator and a second initiator that comprises at least one cationic initiator. The initiator blend may further contain at least one ionic accelerator. In an embodiment, the at least one ionic accelerator is a cationic accelerator or an anionic accelerator. In a preferred embodiment, the at least one ionic accelerator is a cationic accelerator. The cationic accelerator may be a thermal radical generator that can facilitate frontal polymerization.

The first and second low molecular weight molecules may be monomers, dimers, trimers, quadramers, pentamers, and the like, all the way to oligomers and are preferably miscible with each other at reaction conditions. Oligomers consist of a few monomer units that are chemically bonded together and generally have number average molecular weights below 10,000 grams per mole, preferably below 5000 g/mole, preferably less than 1000 g/mole and more below 750 g/mole. While it is desirable for the first and second low molecular weight molecules to be compatible with each other, it is also possible to use two low molecular weight molecules that are semi-compatible or even incompatible with each other. Surfactants, block copolymers, and other compatibilizers may be added to the composition to bring about partial or complete miscibility between the first and the second low molecular weight molecules.

The oligomers may be used to produce a crosslinked polymer blend or a blend of a thermoplastic polymer with a crosslinked polymer after both the first and the second low molecular weight molecules are reacted. The low molecular weight molecules used to produce the thermoplastic polymers are those than can be polymerized by free radical polymerization or ionic polymerization. Examples of polymers that can be produced or modified by free radical polymerization or ionic polymerization include poly(meth)acrylates, polyolefins, polystyrene, poly(vinyl acetate), polyacetals, polyacrylics, polyvinyl chlorides, polytetrafluoroethylenes, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfides, polythioesters, polyphosphazenes, polysilazanes, siloxane polymers, epoxy polymers, unsaturated polyester polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, unsaturated polyesterimides, urethane-acrylates, or the like, or a combination thereof. Additional examples include polymers formed from compounds with heterocyclic functionalities or points of unsaturation. These include, among others, oxiranes, oxetanes, oxolanes, thiiranes, thietanes, lactams, lactones and vinyl compounds. Other, unlisted polymers may also be produced as can be appreciated by those skilled in the art. The foregoing polymers can be produced in thermoplastic or crosslinked form following polymerization.

In a preferred embodiment, the foregoing polymers (which are formed after activation of the composition) are present in linear, branched or crosslinked form following polymerization. In an embodiment, the foregoing polymers are present in crosslinked form following polymerization.

The radically reactive species (i.e., the low molecular weight molecules) used in the composition can be monofunctional, difunctional, trifunctional or have functionalities greater than 2, preferably greater than or equal to 3, and preferably greater than or equal to about 4. In an embodiment, the first low molecular weight molecule and the second low molecular weight molecule used in the composition have an average functionality of greater than 2. By using purely monofunctional low molecular weight molecules, gels that actually can flow, and/or that have a melting point (thermoplastic gel) before the ionic polymerization can be manufactured. This means that this system may be used to create very viscous gels that start as a low viscosity liquid, become a high viscosity, but still flowing gel, after a portion of the reaction is conducted, and then undergoes ionic polymerization. In an embodiment, a combination of low molecular weight molecules (e.g., acrylates) including monofunctional and multifunctional low molecular weight molecules are used to give a crosslinked polymer network that would hypothetically “never” flow because it is heavily crosslinked. It can and does easily deform, especially under stress but it would not flow in the traditional sense.

In a preferred embodiment, the first low molecular weight molecule is an acrylate (or a mixture of acrylates) while the second low molecular weight molecule is an epoxy or a mixture of epoxies.

In an embodiment, the first low molecular weight molecule is a monomer represented by Formula (1):

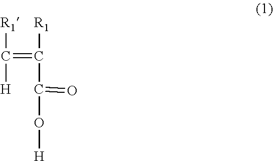

where R₁ is a hydrogen, a hydroxyl, an alkyl group having 1 to 10 carbon atoms, a fluoroalkyl group having 1 to 10 carbon atoms and where R₁′ is hydrogen, a five membered ring or a six membered ring having at least one heteroatom, where the heteroatom is oxygen, nitrogen, sulfur, or phosphorus; or is a monomer represented by Formula (2):

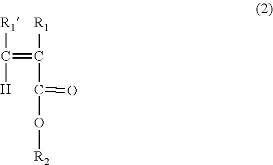

where R₁ is a hydrogen, a hydroxyl, an alkyl group having 1 to 10 carbon atoms, or a fluoroalkyl group having 1 to 10 carbon atoms; where R₁′ is hydrogen, a five membered ring or a six membered ring having at least one heteroatom, where the heteroatom is oxygen, nitrogen, sulfur, or phosphorus; and where R₂ is a C₁₋₃₀ alkyl, C₃₋₃₀ cycloalkyl, C₆₋₃₀ aryl, C₇₋₃₀ alkaryl, C₇₋₃₀ aralkyl, C₁₋₃₀ heteroalkyl, C₃₋₃₀ heterocycloalkyl, C₆₋₃₀ heteroaryl, C₇₋₃₀ heteroalkaryl, C₇₋₃₀ heteroaralkyl, a C₂₋₁₀ fluoroalkyl group, an alkylene oxide, or a combination comprising at least one of the foregoing groups.

In another embodiment, the first low molecular weight molecule is a monomer represented by Formula (3):

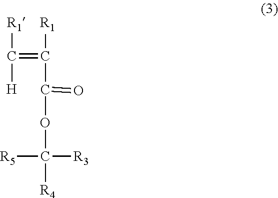

where R₁ is a hydrogen, a hydroxyl, an alkyl group having 1 to 10 carbon atoms, or a fluoroalkyl group having 1 to 10 carbon atoms; where R₁′ is hydrogen, a five membered ring or a six membered ring having at least one heteroatom, where the heteroatom is oxygen, nitrogen, sulfur, or phosphorus; where at least one of R₃, R₄ and R₅ is a C₁₋₃₀ alkyl, C₃₋₃₀ cycloalkyl, C₆₋₃₀ aryl, C₇₋₃₀ alkaryl, C₇₋₃₀ aralkyl, C₁₋₃₀ heteroalkyl, C₃₋₃₀ heterocycloalkyl, C₆₋₃₀ heteroaryl, C₇₋₃₀ heteroalkaryl, C₇₋₃₀ heteroaralkyl, a C₂₋₁₀ fluoroalkyl group, an alkylene oxide, or a combination comprising at least one of the foregoing groups, where each of the groups is covalently bonded to one or more vinyl groups.

Examples of suitable acrylates that may be used in the composition for the frontally polymerizing system include 2-(2-ethoxyethoxy)ethyl acrylate (EOEOEA), tetrahydrofurfuryl acrylate (THFA), lauryl acrylate, phenoxyethyl acrylate, isodecyl acrylate, tridecyl acrylate, ethoxylated nonylphenyol acrylate, isobornyl acrylate (IBOA), poly(propylene glycol) acrylate, poly(propylene glycol) methacrylate, poly(ethylene glycol) acrylate, poly(ethylene glycol) methacrylate, ethoxylated bisphenol A diacrylate, bisphenol A glycerolate diacrylate, polyethyleneglycol diacrylate (PEGDA), alkoxylated diacrylate, propoxylated neopentylglycol diacrylate (NPGPODA), ethoxylated neopentylglycol diacrylate (NPGEODA), dihydroxyhexane diacrylate (HDDA), tetraethyleneglycol diacrylate (TTEGDA), triethyleneglycol diacrylate (TIEGDA), tripropyleneglycol diacrylate, (TPGDA), dipropyleneglycol diacrylate (DPGDA), ditrimethylolpropane tetraacrylate (DiTMPTTA), tris-(2-hyd roxyethyl)-isocyanurate triacrylate (THEICTA), dipentaerythritol pentaacrylate (DiPEPA), ethoxylated trimethylolpropane triacrylate (TMPEOTA), propoxylated trimethylolpropane triacrylate (TMPPOTA), ethoxylated pentaerythritol tetraacrylate (PPTTA), propoxylated glyceryl triacrylate (GPTA), pentaerythritol tetraacrylate (PETTA), trimethylolpropane triacrylate (TMPTA) pentaerythritol triacrylate and modified pentaerythritol triacrylate; methacrylates, such as allyl methacrylate (AMA), tetrahydrofurfuryl methacrylate (THFMA), phenoxyethyl methacrylate, isobornyl methacrylate, triethyleneglycol dimethacrylate (TIEGDMA), ethyleneglycol dimethacrylate (EGDMA), tetraethyleneglycol dimethacrylate (TTEGDMA), polyethyleneglycol dimethacrylate (PEGDMA), butanediol dimethacrylate (BDDMA), diethyleneglycol dimethacrylate (DEGDMA), dihydroxyhexane dimethacrylate (HDDMA), polyethyleneglycol dimethacrylate (PEGDMA), butyleneglycol dimethacrylate (BGDMA), ethoxylated bisphenol A dimethacrylate, trimethylolpropane trimethacrylate (TMPTMA); and/or mono or higher functional oligomers or prepolymers of acrylates or methacrylates, such as polyester and/or polyether (meth)acrylates, optionally fatty acid-modified bisphenol epoxy (meth)acrylates, epoxidized soybean oil methacrylates, epoxy novolak (meth)acrylates, aromatic and/or aliphatic (meth)acrylate oligomers, epoxy (meth)acrylates, amine-modified polyether (meth)acrylate oligomers, aromatic and/or aliphatic urethane (meth)acrylates, glycidyl methacrylate, 2,3-epoxycyclohexyl (meth)acrylate, (2,3-epoxycyclohexyl)methyl (meth)acrylate, 5,6-epoxynorbornene (meth)acrylate, epoxydicyclopentadienyl (meth)acrylate, trifluoroethyl methacrylate, dodecafluoroheptylmethacrylate, or the like, or a combination thereof.

In an embodiment, the first low molecular weight molecule may comprise two or more low molecular weight molecules of a particular species. For example, the first low molecular weight molecule may comprise a first primary low molecular weight molecule, a first secondary low molecular weight molecule, a first tertiary low molecular weight molecule, and so on. In an embodiment, the first primary low molecular weight molecule may have the same or a different number of reactive groups (that can lend themselves to a reaction) from the first secondary low molecular weight molecule, while the first tertiary low molecular weight molecule, if present, may have a different number of reactive groups than either the first primary or the first secondary low molecular weight molecule.

When the first low molecular weight molecule comprises two or more different low molecular weight molecules (the first primary, first secondary and/or first tertiary low molecular weight molecules), then each low molecular weight molecule may be present in an amount of 1 to 35 wt %, preferably 2 to 25 wt %, preferably 2.5 to 15 wt %, and more preferably 3 to 8 wt % based on the total weight of the composition.

Exemplary acrylates are trimethylolpropane triacrylate, isobornyl acrylate, pentaerythritol triacrylate, tetrahydrofurfuryl acrylate, or mixtures thereof. In this instance, the first primary low molecular weight molecule is the trimethylolpropane triacrylate, while the first secondary low molecular weight molecule is the isobornyl acrylate.

When the first low molecular weight molecule comprises two or more different acrylate molecules, then each of the low molecular weight acrylate molecules (the first primary or the first secondary low molecular weight molecules) may be present in an amount of 1 to 35 wt %, preferably 2 to 25 wt %, preferably 2.5 to 15 wt %, and more preferably 3 to 8 wt %, based on the total weight of the composition.

When the first low molecular weight molecule (e.g., the combined weight of the first primary low molecular weight molecule, the first secondary low molecular weight molecule, first tertiary low molecular weight molecule, and so on) is used in the composition it is used in an amount of 1 to 75 wt %, preferably 2 to 50 wt %, preferably 5 to 45 wt % and more preferably 7 to 15 wt %, based on the total weight of the composition.

In a preferred embodiment, the second low molecular weight molecule is ionically polymerizable. In a preferred embodiment, the ionically polymerizable molecules include cationically polymerizable molecules. Examples of cationically polymerizable molecules include epoxies (oxirane), thiiranes (episulfides), oxetanes, lactams, lactones, lactides, glycolides, tetrahydrofuran, or a mixture thereof.

In an embodiment, the second low molecular weight molecule may include aromatic, aliphatic or cycloaliphatic epoxy resins. These are compounds having at least one, preferably at least two, epoxy groups in the molecule. Examples of such epoxy resins are the glycidyl ethers and β-methylglycidyl ethers of aliphatic or cycloaliphatic diols or polyols, e.g., those of ethylene glycol, propane-1,2-diol, propane-1,3-diol, butane-,4-diol, diethylene glycol, polyethylene glycol, polypropylene glycol, glycerol, trimethylolpropane or 1,4-dimethylolcyclohexane, or of 2,2-bis(4-hydroxycyclohexyl) propane and N,N-bis(2-hydroxyethyl)aniline; the glycidyl ethers of di- and polyphenols, typically of resorcinol, of 4,4′-dihydroxyphenyl-2,2-propane, of novolaks or of 1,1,2,2-tetrakis(4-hydroxyphenyl)ethane. Illustrative examples are phenyl glycidyl ether, p-tert-butyl glycidyl ether, o-icresyl glycidyl ether, polytetrahydrofuran glycidyl ether, n-butyl glycidyl ether, 2-ethylhexyl glycidyl ether, C₁₂₋₁₅ alkyl glycidyl ether, cyclohexanedimethanol diglycidyl ether. Other examples are N-glycidyl compounds, typically the glycidyl compounds of ethylene urea, 1,3-propylene urea or 5-dimethylhydantoin or of 4,4′-methylene-5,5′-tetramethyidi-hydantoin, or e.g., triglycidyl isocyanurate.

Other technically important glycidyl compounds are the glycidyl esters of carboxylic acid, preferably di- and polycarboxylic acids. Typical examples are the glycidyl esters of succinic acid, adipic acid, azelaic acid, sebacic acid, phthalic acid, terephthalic acid, tetra- and hexa-hydrophthalic acid, isophthalic acid or trimellitic acid, or of dimerised fatty acids.

Additional exemplary compounds include epoxy, glycidyl ether and epoxycyclohexyl functional siloxanes and siloxane derivatives such as epoxypropoxypropyl terminated polydimethylsiloxanes and 1,3-bis[2-(3,4-epoxycyclohexyl)ethyl]tetramethyldisiloxane.

Illustrative examples of polyepoxides which are not glycidyl compounds are the epoxides of vinyl cyclohexane and dicyclopentadiene, 3-(3′,4′-epoxicyclohexyl)-8,9-epoxy-2,4-dioxa-spiro[5,5]undecane, of the 3′,4′-epoxycyclohexylmethyl ester of 3,4-epoxycyclohexane carboxylic acid, butadiene diepoxide or isoprene diepoxide, epoxidized linolic acid derivatives or epoxidized polybutadiene.

In an embodiment, a useful epoxy resin is the diglycidyl ether of bisphenol F, also known as Epon 862® and having the structure shown in Formula (4):

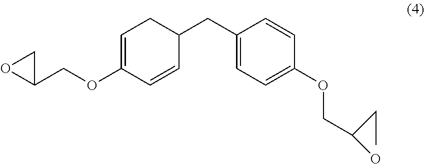 [SMILES: CCC(O)COc1ccc(CC2C=CC(OCC3CO3)=CC2)cc1]

In another embodiment, the epoxy resin is a modified diglycidyl ether of bisphenol F also known as a modified EPON 862® and having the structure shown in Formula (5):

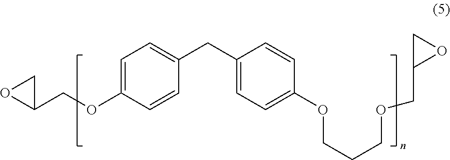

where n is the number of repeat units and can be an amount of 2 to 1000, preferably 3 to 500, and more preferably 4 to 200. The epoxy resin of the formula (5) is produced by polymerizing bisphenol F with the EPON 862.

In an embodiment, the epoxy resin may have the structure shown in the Formula (6) below:

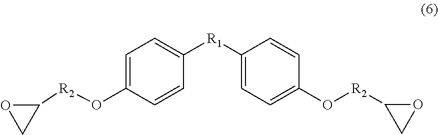

where R₁ is a single bond, —O—, —S—, —C(O)—, or a C₁₋₁₈ organic group. The C₁₋₁₈ organic bridging group may be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In the Formula (6), R₂ is a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

In yet another exemplary embodiment, the epoxy resin is the reaction product of 2-(chloromethyl)oxirane and 4-[2-(4-hydroxyphenyl)propan-2-yl]phenol also known as bisphenol A-epichlorohydrin based epoxy (also known as bisphenol A diglycidyl ether) of the Formula (7) below:

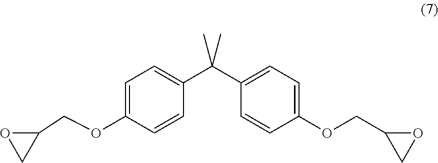 [SMILES: CC(C)(c1ccc(OCC2CO2)cc1)c1ccc(OCC2CO2)cc1]

The epoxy resin of Formula (7) is commercially available as EPON 828. A polymeric version of the epoxy resin of the Formula (7) is shown in Formula (7A) and may also be used. An example includes D.E.R. 667 commercially available from DOW Chemical.

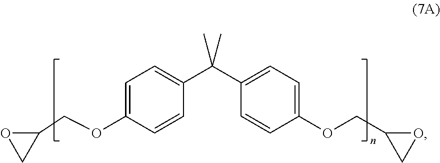

where n can be an amount of 2 to 1000, preferably 3 to 500, and more preferably 4 to 200.

Other exemplary variations of Formula (6) that may be used are shown in the Formulas (8) and (9). In an embodiment, one variation of the Formula (6) that may be used is shown in the Formula (8) below.

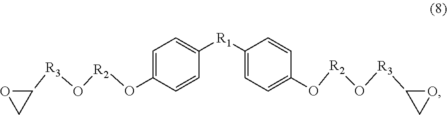

where R₁ is detailed above in Formula (6), R₂ and R₃ may be the same or different and are independently a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

In an exemplary embodiment, an epoxy having the structure of Formula (9) may be used in the composition.

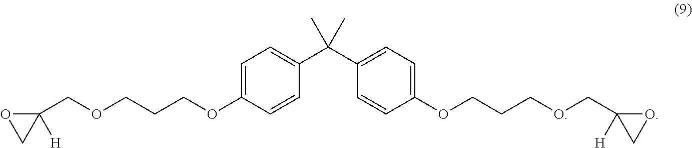 [SMILES: CC(C)(c1ccc(OCCCOCC2CO2)cc1)c1ccc(OCCCOCC2CO2)cc1]

Examples of suitable epoxies are diglycidyl ether of bisphenol A, diomethane diglycidyl ether, 2,2-bis(4-glycidyloxyphenyl)propane, 2,2′-((1-methylethylidene)bis(4,1-phenyleneoxymethylene))bisoxirane, 2,2-bis(4-(2,3-epoxypropyloxy)phenyl)propane, 2,2-bis(4-hydroxyphenyl)propane, diglycidyl ether, 2,2-bis(p-glycidyloxyphenyl)propane, 4,4′-bis(2,3-epoxypropoxy)diphenyldimethylmethane, 4,4′-dihydroxydiphenyldimethylmethane diglycidyl ether, 4,4′-isopropylidenebis(1-(2,3-epoxypropoxy)benzene), 4,4′-isopropylidenediphenol diglycidyl ether, bis(4-glycidyloxyphenyl)dimethylmethane, bis(4-hydroxyphenyl)dimethylmethane diglycidyl ether, diglycidyl ether of bisphenol F, 2-(butoxymethyl)oxirane, the reaction product of 2-(chloromethyl)oxirane and 4-[2-(4-hydroxyphenyl)propan-2-yl]phenol also known as bisphenol A-epichlorohydrin based epoxy, modified bisphenol A-epichlorohydrin based epoxy, diglycidyl 1,2-cyclohexanedicarboxylate, 1,4-cyclohexanedimethanol diglycidyl ether, a mixture of cis and trans 1,4-cyclohexanedimethanol diglycidyl ether, neopentyl glycol diglycidyl ether, resorcinol diglycidyl ether, 4,4′-methylenebis(N,N-diglycidylaniline), 3,4-epoxycyclohexylmethyl 3,4-epoxycyclohexanecarboxylate, 3,4-epoxy-1-cyclohexanecarboxylic acid, 3,4-epoxycyclohexan-1-yl)methyl ester, tert-butyl glycidyl ether, 2-Ethylhexyl glycidyl ether, epoxypropoxypropyl terminated polydimethylsiloxanes, neopentyl glycol diglycidyl ether, 1,4-cyclohexanedimethanol diglycidyl ether, 1,3-bis[2-(3,4-epoxycyclohexyl)ethyl]tetramethyldisiloxane, trimethylolpropane triglycidyl ether, diglycidyl 1,2-cyclohexanedicarboxylate, or the like, or a combination comprising at least one of the foregoing epoxy resins.

Another second low molecular weight molecule may include an oxetane that has a four membered ring ether that has the structure of Formula (10)

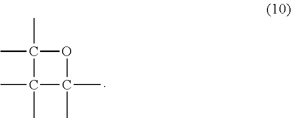

Exemplary oxetane compounds include, for example, 3-ethyl-3-hydroxymethyloxetane, 1,4 bis{[(3-ethyl-3-oxetanyl)methoxy]methyl}benzene, 3-ethyl-3-(phenoxymethyl)oxetane, 3-ethyl-3-(2-ethylhexyloxymethyl)oxetane, di[1-ethyl(3-oxetanyl)]methyl ether, or the like, or a combination thereof.

In an embodiment, the second low molecular weight molecule may comprise two or more low molecular weight molecules of a particular species. For example, the second low molecular weight molecule may comprise a second primary low molecular weight molecule, a second secondary low molecular weight molecule, a second tertiary low molecular weight molecule, and so on. In an embodiment, the second primary low molecular weight molecule may have the same or a different number of reactive groups (that can lend themselves to a reaction) from the second secondary low molecular weight molecule, while the second tertiary low molecular weight molecule, if present, may have a different number of reactive groups than either the second primary or the second secondary low molecular weight molecule. In an embodiment, hydroxyl functional low molecular weight molecules may be copolymerized with an epoxy in a cationic process and are an important comonomer for use in the composition.

Exemplary epoxies are bisphenol A diglycidyl ether, 3,4-epoxycyclohexylmethyl 3,4-epoxycyclohexanecarboxylate, or mixtures thereof. In this instance, the second primary low molecular weight molecule is the 3,4-epoxycyclohexylmethyl 3,4-epoxycyclohexanecarboxylate, while the second secondary low molecular weight molecule is the bisphenol A diglycidyl ether.

When the second low molecular weight molecule comprises two or more different epoxy molecules, then the second primary low molecular weight molecule may be present in an amount of 10 to 65 wt %, preferably 30 to 55 wt %, and more preferably 45 to 53 wt %, based on the total weight of the composition. The second secondary low molecular weight molecule may be present in an amount of 10 to 45 wt %, preferably 25 to 40 wt %, and more preferably 30 to 40 wt %, based on the total weight of the composition.

When the second low molecular weight molecule is used in the composition (e.g., the combined weight percentage of the second primary low molecular weight molecule, the second secondary low molecular weight molecule, the second tertiary low molecular weight molecule, and so on) it is used in an amount of 25 to 99 wt %, preferably 40 to 95 wt %, preferably 45 to 90 wt %, preferably 65 to 95 wt %, more preferably 70 to 90 wt %, and more preferably 75 to 88 wt %, based on the total weight of the composition.

The composition may comprise two or more initiators that are used to react the first low molecular weight molecules and/or the second low molecular weight molecules to form polymers. The first low molecular weight molecule forms a first polymeric network while the second low molecular weight molecule forms a second polymeric network. In an embodiment, the first polymeric network is formed prior the second polymeric network.

The polymers formed as a result of the reaction may be linear polymers, branched polymers or crosslinked polymers. At least one of the polymers is a crosslinked polymer. In a preferred embodiment, both the polymers (the first polymeric network and the second polymeric network) are crosslinked polymers. In another preferred embodiment, the crosslinked polymers form an interpenetrating network. In an embodiment, the two separate polymers (i.e. acrylate and epoxy) may actually be reacted with each other during the ionic polymerization. If the acrylates contain hydroxyl groups (as well as other reactive functional groups) then the epoxies can actually grow from them. In an embodiment, the ionically polymerizing network may actually be reacted with the already radically polymerized first network. For example, if the acrylates have hydroxyl functionalities then these may react with the polymerizing epoxy network.

In another embodiment, both the polymers (the first polymeric network and the second polymeric network) are linear polymers that may not be crosslinked.

The initiators may be added to the composition in the form of an initiator package. The initiators may be photoinitiators, thermal initiators, or a combination thereof. In some embodiments, photoinitiators can be thermal initiators or vice-versa depending upon the initiation or polymerization temperature of the low molecular weight molecules. A thermal radical generator may be added if desired. The thermal radical generator dissociates under heat to produce radicals that aid in the oxidation of the ionic initiator.

In general, a radical initiator generates radicals upon activation that promote polymerization of the low molecular weight molecule. In the case of photoinitiators, the activation energy is derived primarily from electromagnetic radiation (e.g., ultraviolet light, visible light, xrays, electrons, protons, or a combination thereof) while in the case of thermal initiators, the activation energy is derived from heat (e.g., conduction or convection) or electromagnetic radiation that involves the generation of heat (e.g., infrared radiation, microwave radiation, or a combination thereof). Induction heating may also be used.

In an embodiment, the first activation stimuli and the second activation stimuli may be the same forms of stimuli but of different intensity. For example, the first and second activation stimuli can be UV radiation but of different frequencies or energy levels. They can also both be thermal stimulation (e.g., brought about by placing the sample in an oven) but at different temperatures.

The initiators generally possess weak bonds—bonds that have small bond dissociation energies. Examples of radical initiators are halogen molecules, azo compounds, onium compounds, phosphine oxides, organic and inorganic peroxides, or the like, or a combination thereof. The initiators used in the composition depend upon the type of low molecular weight molecules that are to be polymerized, and the desired activation stimulus.

Halogens undergo the homolytic fission relatively easily. Chlorine, for example, gives two chlorine radicals (Cl.) by irradiation with ultraviolet light. Organic peroxides each have a peroxide bond (—O—O—), which is readily cleaved to give two oxygen-centered radicals. The oxyl radicals are unstable and believed to be transformed into relatively stable carbon-centered radicals. For example, di-tert-butyl peroxide (tBuOOtBu) gives two t-butanoyl radicals (tBuO.) and the radicals become methyl radicals (CH3.) with the loss of acetone. Benzoyl peroxide ((PhCOO)2) generates benzoyloxyl radicals (PhCOO.), each of which loses carbon dioxide to be converted into a phenyl radical (Ph.). Methyl ethyl ketone peroxide is also common, and acetone peroxide is on rare occasions used as a radical initiator, too. Inorganic peroxides function analogously to organic peroxides. Many polymers are often produced from the alkenes upon initiation with peroxydisulfate salts. In solution, peroxydisulfate dissociates to give sulfate radicals. In atom transfer radical polymerization (ATRP) carbon-halides reversibly generate organic radicals in the presence of transition metal catalyst. Azo compounds (R—N═N—R′) can be the precursor of two carbon-centered radicals (R. and R′.) and nitrogen gas upon heating and/or by irradiation. The free radical initiators selected for us in the composition depend upon the low molecular weight molecules, and the desired activation stimulus.

In an embodiment, when the composition contains acrylate and epoxy low molecular weight molecules, a suitable cationic initiator may be used for polymerizing the epoxy resin. Exemplary cationic initiators are onium salts containing a SbF₆, PF₆, BF₄, AlO₄C₁₂F₃₆ or a C₂₄BF₂₀ anion. Examples of suitable cationic initiators for reacting the epoxy resins are bis(4-hexylphenyl)iodonium hexafluoroantimonate, bis(4-hexylphenyl)iodonium hexafluorophosphate, (4-hexylphenyl)phenyliodonium hexafluoroantimonate, (4-hexylphenyl)phenyliodonium hexafluorophosphate, bis(4-octylphenyl)iodonium hexafluoroantimonate, [4-(2-hydroxytetradecyloxy)phenyl]phenyliodonium hexafluoroantimonate, [4-(2-hydroxydodecyloxy)phenyl]phenyliodonium hexafluoroantimonate, bis(4-octylphenyl)iodonium hexafluorophosphate, (4-octylphenyl)phenyliodonium hexafluoroantimonate, (4-octylphenyl)phenyliodonium hexafluorophosphate, bis(4-decylphenyl)iodonium hexafluoroantimonate, bis(4-decylphenyl)iodonium hexafluorophosphate, (4-decylphenyl)phenyliodonium hexafluoroantimonate, (4-decylphenyl)phenyliodonium hexafluorophosphate, (4-octyloxyphenyl)phenyliodonium hexafluoroantimonate, (4-octyloxyphenyl)phenyliodonium hexafluorophosphate, (2-hydroxydodecyloxyphenyl)phenyliodonium hexafluoroantimonate, (2-hydroxydodecyloxyphenyl)phenyliodonium hexafluorophosphate, bis(4-hexylphenyl)iodonium tetrafluoroborate, (4-hexylphenyl)phenyliodonium tetrafluoroborate, bis(4-octylphenyl)iodonium tetrafluoroborate, (4-octylphenyl)phenyliodonium tetrafluoroborate, bis(4-decylphenyl)iodonium tetrafluoroborate, bis(4-(mixed C₈-C₄alkyl)phenyl)iodonium hexafluoroantimonate, (4-decylphenyl)phenyliodonium tetrafluoroborate, (4-octyloxyphenyl)phenyliodonium tetrafluoroborate, (2-hydroxydodecyloxyphenyl)phenyliodonium tetrafluoroborate, biphenylene iodonium tetrafluoroborate, biphenylene iodonium hexafluorophosphate, biphenylene iodonium hexafluoroantimonate, bis(4-tert-butylphenyl)iodonium perfluoro-1-butanesulfonate electronic grade, bis(4-tert-butylphenyl)iodonium p-toluenesulfonate electronic grade, (p-isopropylphenyl)(p-methylphenyl)iodonium tetrakis(pentafluorophenyl) borate, bis(4-tert-butylphenyl)iodonium triflate electronic grade, boc-methoxyphenyldiphenylsulfonium triflate, (4-tert-butylphenyl)diphenylsulfonium triflate, diphenyliodonium hexafluorophosphate, diphenyliodonium nitrate, diphenyliodonium perfluoro-1-butanesulfonate electronic grade, diphenyliodonium p-toluenesulfonate, diphenyliodonium triflate electronic grade, (4-fluorophenyl)diphenylsulfonium triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, 1-naphthyl diphenylsulfonium triflate, (4-phenoxyphenyl)diphenylsulfonium triflate, (4-phenylthiophenyl)diphenylsulfonium triflate, triarylsulfonium hexafluoroantimonate salts, triarylsulfonium hexafluorophosphate, triphenylsulfonium perfluoro-1-butanesufonate, diphenyliodonium tetrakis(perfluoro-t-butyloxy)aluminate or the like or a combination thereof. An exemplary cationic initiator is p-(octyloxyphenyl)phenyliodonium hexafluoroantimonate.

Cationic photoinitiators are used in amounts of 0.5 to 5 wt %, preferably 1 to 4 wt % and more preferably 1.5 to 3 wt %, based on the total weight of the composition.

A suitable thermal radical generator may also be added to the cationic initiator to facilitate the frontal polymerization of the epoxy. Pinacol and its derivatives may be used as thermal initiators. Suitable thermal radical generators include benzopinacol, 4,4′-dichlorobenzopinacol, 4,4′-dibromobenzopinacol, 4,4′-diiodobenzopinacol, 4,4′,4″,4′″-tetrachlorobenzopinacol, 2,4-2′,4′-tetrachlorobenzopinacol, 4,4′-dimethylbenzopinacol, 3,3′-dimethylbenzopinacol, 2,2′-dimethylbenzopinacol, 3,4-3′,4′-tetramethylbenzopinacol, 4,4′-dimethoxybenzopinacol, 4,4′,4″,4′″-tetramethoxybenzopinacol, 4,4′-diphenylbenzopinacol, 4,4′-dichloro-4″,4″′-dimethylbenzopinacol, 4,4′-dimethyl-4″,4″′-diphenylbenzopinacol, xanthonpinacol, fluorenonepinacol, acetophenonepinacol, 4,4′-dimethylacetophenone-pinacol, 4,4′-dichloroacetophenonepinacol, 1,1,2-triphenyl-propane-1,2-diol, 1,2,3,4-tetraphenylbutane-2,3-diol, 1,2-diphenylcyclobutane-1,2-diol, propiophenone-pinacol, 4,4′-dimethylpropiophenone-pinacol, 2,2′-ethyl-3,3′-dimethoxypropiophenone-pinacol, 1,1,1,4,4,4-hexafluoro-2,3-diphenyl-butane-2,3-diol, or the like, or a combination thereof. Other thermal radical generators mentioned in U.S. Pat. No. 4,330,638 to Wolfers may also be used if desired. Trialkylsilyl protected benzopinacols may also be used. An exemplary thermal radical generator is benzopinacol.

Thermal radical generators are used in amounts of 0.5 to 5 wt %, preferably 1 to 4 wt % and more preferably 1.5 to 3 wt %, based on the total weight of the composition. In an embodiment, the first radical initiator (that is used to polymerize the acrylate) can interact with the thermal radical generator during the first polymerization reaction. Excess thermal radical generator may therefore need to be used in the composition in order to facilitate utility during the cationic reaction.

The ionic photoinitiator and the thermal radical generator are used in a mole ratio of 1:10 to 10:1, preferably 1:5 to 5:1. A preferred mole ratio is 1:3. In an embodiment, the ionic photoinitiator is a cationic initiator. The cationic photoinitiator and the thermal radical generator are used in a mole ratio of 1:10 to 10:1, preferably 1:5 to 5:1.

The free radical photoinitiator and the thermal radical generator may be used in in a mole ratio of 1:10 to 10:1, preferably 1:5 to 5:1. A preferred mole ratio is 1:4.

Exemplary radical initiators that may be used to polymerize the low molecular weight molecules include tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tertbutylperoxy)cyclohexane, 2,5-bis(tertbutylperoxy)-125 (benzene) 2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate benzene, tert-butyl peroxide, tert-butyl peroxybenzoate, tertbutylperoxy isopropyl carbonate, cumene hydroperoxide, cyclohexanone peroxide, dicumyl peroxide, lauroyl peroxide, 2,4-pentanedione peroxide, peracetic acid, potassium persulfate, camphorquinone amine, diphenyl(2,4,6 trimethylbenzoyl)phosphine oxide, or the like, or a combination thereof.

An exemplary radical photoinitiator is diphenyl(2,4,6 trimethylbenzoyl)phosphine oxide. The radical initiators are used in amounts of 0.01 to 5 wt %, preferably 0.05 to 4 wt % and more preferably 0.1 to 3 wt %, based on the total weight of the composition.

In an embodiment, either photoinitiators or thermal initiators may be used to react both the first low molecular weight molecules and/or the second low molecular weight molecules to form polymers. In an embodiment, the first low molecular weight molecules may be polymerized using free radicals to form a first polymeric network, while the second low molecular weight molecules may be polymerized ionically to form a second polymeric network. The first polymeric network is formed without any significant interaction with the ingredients that later react to form the second polymeric network. In other words, the first polymeric network is formed prior to the second polymeric network, i.e., they are formed sequentially.

In another embodiment, photoinitiators may be used to react the first low molecular weight molecules to form polymers while thermal initiators are used to react the second low molecular weight molecules to form polymers. In an additional embodiment, thermal initiators may be used to react the first low molecular weight molecules to form polymers while photoinitiators are used to react the second low molecular weight molecules to form polymers. In an exemplary embodiment, photoinitiators may be used to crosslink the first low molecular weight molecules while a combination of initiators are used to crosslink the second low molecular weight molecules. When the composition comprises epoxies as the first low molecular weight molecule and acrylates as the second low molecular weight molecule, a mixture of a thermal radical generator and an ionic photoinitiator may be used to polymerize the epoxy while the photoinitiator may be used to polymerize the acrylate.

The composition may also contain additional ingredients such as crosslinking agents, hardeners, reactive or non-reactive diluents, fillers, fibers, chain transfer agents, UV stabilizers, UV absorbers, dyes, anti-ozonants, thermal stabilizers, inhibitors, viscosity modifiers, plasticizers, solvents, polymers, phase separating agents or the like, or a combination thereof. The composition may be devoid of solvents or diluents if desired.

Diluents may also be used in the composition. The diluents may be reactive (i.e., they can react with the low molecule weight molecules to be a part of the network) or be non-reactive. Examples of suitable diluents are alcohols, ethyl vinyl ether, n-butyl vinyl ether, isobutyl vinyl ether, octadecyl vinyl ether, cyclohexyl vinyl ether, dihydroxybutane divinyl ether, hydroxybutyl vinyl ether, cyclohexane dimethanol monovinyl ether, diethyleneglycol divinyl ether, triethyleneglycol divinyl ether, n-propylvinyl vinyl ether, isopropyl vinyl ether, dodecyl vinyl ether, diethyleneglycol monovinyl ether, cyclohexane dimethanol divinyl ether, trimethylolpropane trivinyl ether and vinyl ether, which can be obtained, for example, by the addition of acetylene to alcohols, as well as oligomers and polymers, which contain vinyl ether groups and are obtained, for example, by the addition of acetylene to hydroxyl group-containing oligomers and/or polymers or by the reaction of alkyl vinyl ethers with reactive monomers, oligomers and/or polymers, especially by the reaction of isocyanates and isocyanate prepolymers with hydroxy-functional alkyl vinyl ethers.

In an embodiment, the diluent may be a polymer. Suitable polymers are thermoplastic polymers. Any of the polymers listed above may be used as a diluent, if so desired. The polymers generally have a weight average molecular weight of greater than 10,000 grams per mole, preferably greater than 15,000 grams per mole, and more preferably greater than 20,000 grams per mole.

In an embodiment, in one method of manufacturing an article, the composition for the frontally polymerizing system is prepared by mixing together at least two or more reactive small molecules with an initiator package comprising two or more initiators—a free radical initiator and an ionic initiator. To the composition may also be added a frontal cationic accelerator or a thermal radical generator if desired. The mixing of the reactants may be conducted in a reduced light environment at a temperature conducive to dissolving the respective components but not high enough to induce the dissociation of the initiators.

The composition may then be disposed on a surface or in a mold and subjected to a first reaction that includes activating one of the free radical initiator or the ionic initiator.

In a preferred embodiment, the conversion of the first low molecular weight molecule to a polymer is conducted prior to the conversion of the second low molecular weight molecule to a polymer. After the conversion of the first low molecular weight molecule to a polymer, the partially reacted composition is free standing and further reactions on the system can be pursued in a geometrically unconstrained fashion. After the first reaction takes place, the partially reacted composition (produced by the conversion of the first low molecular weight molecule to a polymer) has a sufficiently high viscosity that it does not undergo any further flow. The second reaction can then be activated to polymerize the second low molecular weight molecule.

In another embodiment, a first layer of the composition may be disposed on a substrate. The first low molecular weight molecule in the first layer is polymerized either by radiation or by thermal heat transfer producing a partially reacted composition. The second low molecular weight molecule in the first layer is nominally unreacted during the polymerization of the first low molecular weight molecule. A second layer of the composition is then disposed on the first layer and has its first low molecular weight molecule also polymerized either by radiation or by thermal heat transfer producing a partially reacted composition. In this manner a plurality of layers may be disposed atop one another and each partially reacted by radiation or by thermal heat transfer. The partially reacted multilayer article is stable and can maintain its geometrical configuration without any external support, temperature adjustments or internal pressure. Following the disposal of the requisite number of layers atop one another on the substrate, the second low molecular weight molecule is reacted using either radiation or by thermal heat transfer. The second low molecular weight molecule undergoes reaction in a frontal polymerization process, where the polymerization is first initiated at a point or plane of contact and then progresses through the multilayer article along a front with the passage of time. The polymerization of the second polymer promotes bonding between the various layers to produce a monolithic (a single unitary body) article. This method of producing an article may be used in additive manufacturing or in 3D printing. The frontal polymerization can also be started before all of the layers are done being deposited. As long as the front is slow enough the additional final layers can be laid down before the front reaches them. This can be used to speed up the process if so desired.

In another embodiment, the entire part may also be put in an oven to fully cure, e.g., not via frontal polymerization but rather by a global polymerization of the entire part. In other words, the first polymerization reaction and the second polymerization reaction may be conducted sequentially or simultaneously in an oven, but not via a frontal polymerization.

Alternatively, the polymerization of the second polymer in a frontal manner can be conducted simultaneously with the deposition of additional layers provided that the additional layers are disposed on the article before the moving polymerization front reaches the area of deposition.

In an embodiment, the first low molecular weight molecule is an acrylate and its reaction to form a polymer proceeds by a free radical polymerization mechanism where the source of reaction activation is ultraviolet radiation. In an embodiment, the polymerization of the acrylate results in a first crosslinked polymer. Following the polymerization of the acrylate, the second low molecular weight molecule, which is an epoxy, is polymerized by cationic polymerization. This reaction proceeds via frontal polymerization (or via global polymerization of the entire part) and is initiated by thermal contact of the partially reacted composition by a source of heat. As noted above, the source of heat may affect a thermal transfer by conduction or convection. The source of heat may also be radiation from microwaves or a laser beam. The area of contact (or UV exposure) has a faster polymerization rate, and the energy from the exothermic polymerization diffuses into the adjacent region, raising the temperature and increasing the reaction rate in that location. The result is a localized reaction zone that propagates down the layer as a thermal wave. In other words, the second reaction proceeds via a spatially propagating reaction front.

The radiation used to react the first and/or the second low molecular weight monomer has a wavelength in the range of 220 to 700 nanometers but preferably between 320 and 450 nanometers. The temperature of the source of heat at the time of contact is preferably 30 to 200° C.

In yet another embodiment, the composition can be reacted in a geometrically unconstrained environment irrespective of article thickness. The term “geometrically unconstrained environment” implies that the reaction mixture may be freestanding after at least one of the stimuli has been applied to the composition and that the composition does not show any substantial flow prior to being subjected to the second stimuli irrespective of its thickness.

The composition and the method of manufacturing disclosed herein are exemplified by the following non-limiting examples.

### EXAMPLE

### Example 1

This example demonstrates the polymerization of a mixture of a first low molecular weight molecule (an acrylate) and a second low molecular weight molecule (an epoxy) via frontal polymerization. The example uses acrylate and epoxy (including epoxycyclohexyl and diglycidyl ether) functional monomers. The initiator system contains a free radical photoinitiator to crosslink the acrylate and a combination of a thermal radical generator and a cationic initiator to crosslink the epoxy.

In this embodiment the free radical photoinitiator is a phosphine oxide compound while the thermal radical generators and cationic initiators are pinacol derivatives and onium salts respectively. All of these components are soluble and can be mixed together and stored at room temperature away from UV sources. When polymerization is desired, a long wave (365 nm or 405 nm) UV light source is used to dissociate the free radical photoinitiator which results in the polymerization and gelation of the acrylate portion of the mixture. Following gelation, a heat source is applied to initiate frontal polymerization of the epoxy portion. The frontal polymerization travels through the material beginning at the point of heat application. The materials used in the reaction are listed in the Table 1 below.

TABLE 1

| | Frontal Gel Formulation | Weight Percent | Mass (g) | Moles | Mole % |
|---|---|---|---|---|---|
| Epoxy | 3,4-Epoxycyclohexylmethyl 3,4- | 51.570% | 10.31 | 4.088E−02 | 57.85% |
| Portion | epoxycyclohexanecarboxylate | | | | |
| | bisphenol A diglycidyl ether | 34.380% | 6.88 | 2.020E−02 | 28.59% |
| | p-(octyloxyphenyl)phenyliodonium | 2.000% | 0.40 | 3.938E−04 | 0.56% |
| | hexafluoroantimonate | | | | |
| | 1,1,2,2-tetraphenyl-1,2-ethanediol | 2.000% | 0.40 | 1.092E−03 | 1.54% |
| Acrylate | trimethylolpropane triacrylate | 4.775% | 0.96 | 3.223E−03 | 4.56% |
| Portion | isobornyl acrylate | 4.775% | 0.96 | 4.585E−03 | 6.49% |
| | diphenyl(2,4,6 | 0.500% | 0.10 | 2.871E−04 | 0.41% |
| | trimethylbenzoyl)phosphine oxide | | | | |

All components in Table 1 are combined in a glass vial and stirred at 72.0 in dark conditions (the absence of light) until all solids are dissolved. The solution is allowed to cool to room temperature. The solution is then spread on substrate and exposed to long wave UV radiation until a gel forms. The amount of time to gelation is based on the intensity of the UV light. A soldering iron, or other heat source, is then used to initiate thermal frontal polymerization. As noted above, when an entire structure is to be polymerized, the entire structure may be heated at one time (e.g., by placing in an oven). The frontal polymerization travels through the material beginning at the point of heat application.

The gelation of the acrylate proceeds by a free radical polymerization, and is suspected to not interact with the epoxy. This free radical polymerization has a limited effect on the thermal radical generator though, deactivating or consuming it in some way. This has been demonstrated by increasing the amount of free radical photoinitiator without increasing the amount of thermal radical generator, which results in, slowing of the front if not complete inhibition of the front. However, this behavior can be easily compensated for by increasing the amount of thermal radical generator to maintain the effect in this invention.

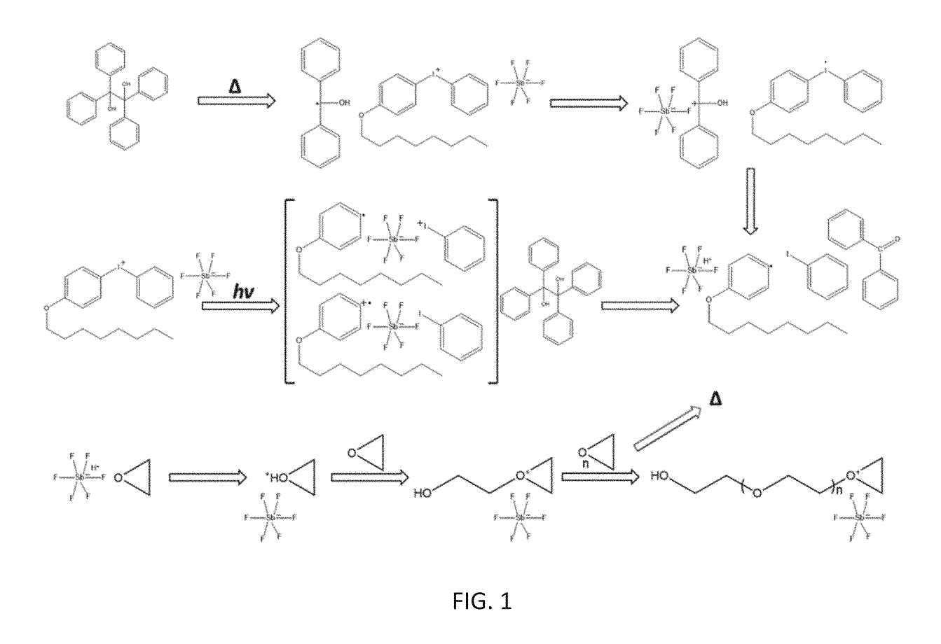

The assumed frontal polymerization of the epoxy portion is depicted in the FIG. 1. The figure shows that it should be possible to initiate the frontal polymerization both with heat or UV radiation. In the demonstrated embodiment heat was used but it is believed that high intensity short wave UV light may be successfully used in initiating the frontal polymerization of the epoxy portion of the formulation. It can be seen in the figure that heat dissociates the thermal radical generator and the resulting radicals formed aid in the oxidation of the cationic initiator. Additionally, a proton from the thermal radical generator is also suspected to transfer to the metal complex of the cationic initiator and this results in the formation of the activated protonic acid which is depicted to initiate the curing of the epoxy system. The front is propagated from the heat released during the ring opening of the epoxy molecules, which is sufficient to dissociate the thermal radical generator in the surrounding material and continue the propagating chain reaction.

The composition used in this example can be stored for extended periods of time. After the acrylate is polymerized, the composition may be stored for more than 1 day, preferably more than 6 days, and preferably more than two weeks before the epoxy is polymerized using thermal activation.

### Example 2

This example use azobisisobutyronitrile (AIBN) as an initiator. The composition is shown in the Table 2. In this example, both the first reaction (the radical polymerization) and the second reaction (the cationic polymerization) were brought about by thermal activation. The composition is identical as that shown in the Example 1, except that AIBN was substituted for diphenyl(2,4,6 trimethylbenzoyl)phosphine oxide in the same molar amount. The composition was gelled under heat at 70° C. (by reacting the acrylate) for one hour, under nitrogen atmosphere. Frontal polymerization was successfully initiated with a soldering iron and propagated through entire sample. The exact temperature of the tip of the soldering iron is not accurately measurable. However, the formulation of Example 1 was crosslinked on a hot plate set at 150° C. This corresponds to the approximate maximum exotherm temperature as measured by differential scanning calorimetry (DSC) when measured at a temperature rate of 10° C./minute.

### Example 3

This example use an epoxy functionalized polybutadiene (for the cationic polymerization) in addition to the acrylate (which was radically polymerized) used in the Examples 1 and 2. The composition is shown in the Table 3 below. The polybutadiene is epoxy functionalized and hydroxy terminated. It was purchased from Sigma Aldrich having a weight average molecular weight of Mw ˜2,600, a number average molecular weight Mn ˜1,300 with an epoxy equivalent weight: 260-330 g. It was cured using the same method as original resin. Ultraviolet light (UVA) was used to initiate the radical polymerization to form the gel. Heat from a soldering iron initiates the cationic reaction that promotes the frontal polymerization.

TABLE 2

| | Frontal Gel Formulation | Weight Percent | Mass (g) | Moles | Mole % |
|---|---|---|---|---|---|
| Epoxy | 3,4-Epoxycyclohexylmethyl 3,4- | 51.707% | 10.314 | 4.088E−02 | 57.85% |
| Portion | epoxycyclohexanecarboxylate | | | | |
| | Bisphenol A Diglycidyl Ether | 34.471% | 6.876 | 2.020E−02 | 28.59% |
| | p-(Octyloxyphenyl)Phenyliodonium | 2.005% | 0.400 | 3.938E−04 | 0.56% |
| | Hexafluoroantimonate | | | | |
| | 1,1,2,2-Tetraphenyl-1,2-Ethanediol | 2.005% | 0.400 | 1.092E−03 | 1.54% |
| Acrylate | Trimethylolpropane triacrylate | 4.788% | 0.955 | 3.223E−03 | 4.56% |
| Portion | Isobornyl Acrylate | 4.788% | 0.955 | 4.585E−03 | 6.49% |
| | Azobisisobutyronitrile | 0.236% | 0.04714 | 2.871E−04 | 0.41% |

TABLE 3

| | Frontal Gel Formulation | Weight Percent | Mass (g) | Moles | Mole % |
|---|---|---|---|---|---|
| Epoxy | 3,4-Epoxycyclohexylmethyl 3,4- | 51.570% | 7.7355 | 3.066E−02 | 74.85% |
| Portion | epoxycyclohexanecarboxylate | | | | |
| | Polybutadiene, epoxy functionalized, | 34.380% | 5.1570 | 1.983E−03 | 4.84% |
| | hydroxy terminated | | | | |
| | p-(Octyloxyphenyl)Phenyliodonium | 2.000% | 0.300 | 2.954E−04 | 0.72% |
| | Hexafluoroantimonate | | | | |
| | 1,1,2,2-Tetraphenyl-1,2-Ethanediol | 2.000% | 0.300 | 8.187E−04 | 2.00% |
| Acrylate | Pentaerythritol triacrylate | 4.775% | 0.71625 | 2.401E−03 | 5.86% |
| Portion | Tetrahydrofurfuryl acrylate | 4.775% | 0.71625 | 4.586E−03 | 11.20% |
| | Diphenyl(2,4,6 | 0.500% | 0.075 | 2.153E−04 | 0.53% |
| | trimethylbenzoyl)phosphine oxide | | | | |

### Example 4

This example was conducted to demonstrate the pot life of the gel. The gel is defined as the resulting composition after one of the low molecular weight materials (e.g., the first low molecular weight material) is reacted.

The formulation shown below (Table 4—which is the same as Example 1) was mixed at 72° C. until all components were dissolved (approximately about 30 minutes). This sample was used for shelf life testing by creating a circular gelled disk for rheological pot life testing. The formulation was dripped in its liquid form into a circular metal mold with a PTFE base and was exposed to a 365 nm UV lamp at 6″ inches (approximately 15 centimeters) for ten minutes, followed by flipping the sample over and exposing it for an additional ten minutes on the opposing side. The resulting sample was a mechanically stable gel that was removed from the mold. The gelled sample had a diameter of 25.67 millimeters (mm), thickness of 2.4 mm, and a weight of 1.3836 grams. This sample was placed in a rheometer between 25 mm parallel metal plates set to a gap width of 2.3 mm. It was then evaluated over the course of 24 hours with frequency sweeps at approximately 14.37 minute intervals.

The frequency sweeps were set to 1% strain and between 1 and 100 radians/second of angular frequency. After 24 hours the sample was removed, placed between waxed paper and stored in a sealed, UV blocking polyolefin bag for ten days. This sample was then removed and frontal polymerization was attempted.

TABLE 4

| | | Weight | Mass |
|---|---|---|---|
| | Frontal Gel Formulation | Percent | (g) |
| Epoxy | 3,4-Epoxycyclohexylmethyl 3,4- | 51.570% | 10.31 |
| Portion | epoxycyclohexanecarboxylate | | |
| | Bisphenol A Diglycidyl Ether | 34.380% | 6.88 |
| | p-(Octyloxyphenyl)Phenyliodonium | 2.000% | 0.40 |
| | Hexafluoroantimonate | | |
| | 1,1,2,2-Tetraphenyl-1,2-Ethanediol | 2.000% | 0.40 |
| Acrylate | Trimethylolpropane triacrylate | 4.775% | 0.96 |
| Portion | Isobomyl Acrylate | 4.775% | 0.96 |
| | Diphenyl(2,4,6 | 0.500% | 0.10 |
| | trimethylbenzoyl)phosphine oxide | | |

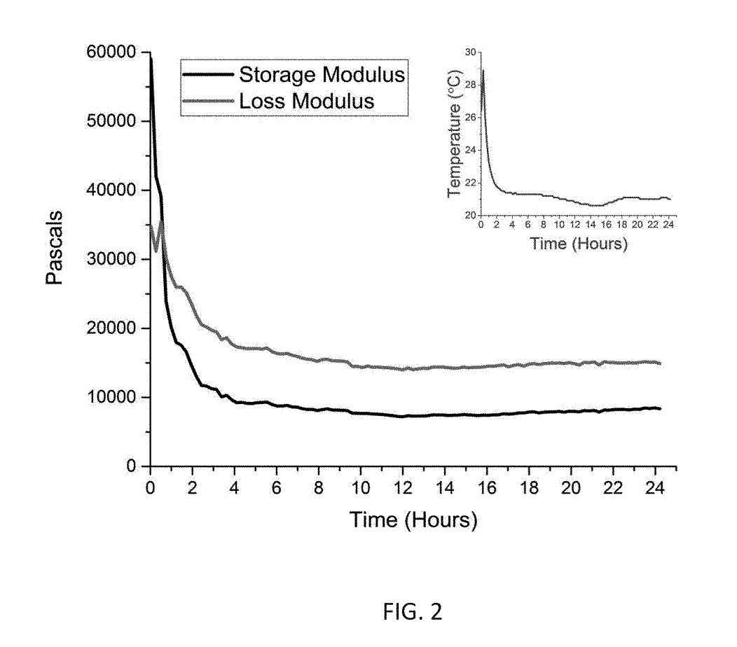

The 10 radians/second angular frequency was chosen as a representative and the storage and loss modulus are plotted versus time in the FIG. 2. FIG. 2 shows the storage and loss modulus plotted against time at 10 radians/second for 24 hours in a gelled sample. The inlaid temperature plot shows increased temperature at early testing times.

FIG. 2 clearly shows that while there may be some transient changes occurring at short time scales, following a few hours in the rheometer a steady state is reached for both the storage and loss modulus, at least over the course of 24 hours. It should also be pointed out that the early transient behavior may not be entirely material dependent since, as can be seen from the inlaid plot, during testing the rheometer heated up slightly to just under 30° C. during the first frequency sweep, due to a method error, and then took some time to come back down to room temperature.

The results from the FIG. 2 show that the samples are thermally stable after gelation (i.e., after one of the polymerization reactions has occurred). In an embodiment, the composition, undergoing radical polymerization (but not the ionic polymerization) displays thermal stability in the form of a constant storage modulus for a period of 3 to 30 hours, preferably 5 to 28 hours, and more preferably 6 to 24 hours after the radical polymerization (i.e., gelation) has occurred. The storage modulus at room temperature and a frequency of 10 radians/second is 9,000 to 11,000, preferably 9,500 to 10,500 Pascals for a period of 3 to 30 hours, preferably 5 to 28 hours, and more preferably 6 to 24 hours after gelation (i.e., one of the reactions has occurred).

The sample, after being stored for ten days, did show signs of the epoxy absorbing slightly into the waxed paper, and had a slight layer of liquid epoxy on its surfaces but did completely frontally polymerize when heat was applied with a soldering iron, indicating that pot life in the gelled sample is greater than ten days.

### Example 5

This example was conducted to demonstrate liquid shelf life. 200 g of the composition shown in Table 4 above was created as a first sample. The first sample, after some portion was removed for other testing, was stored in an amber bottle in a dark cabinet for 502 days. This aged material was then removed and tested for gelation and frontal polymerization. It qualitatively passed both tests. A second sample having the same composition was also created at a substantially later date (502 days later).

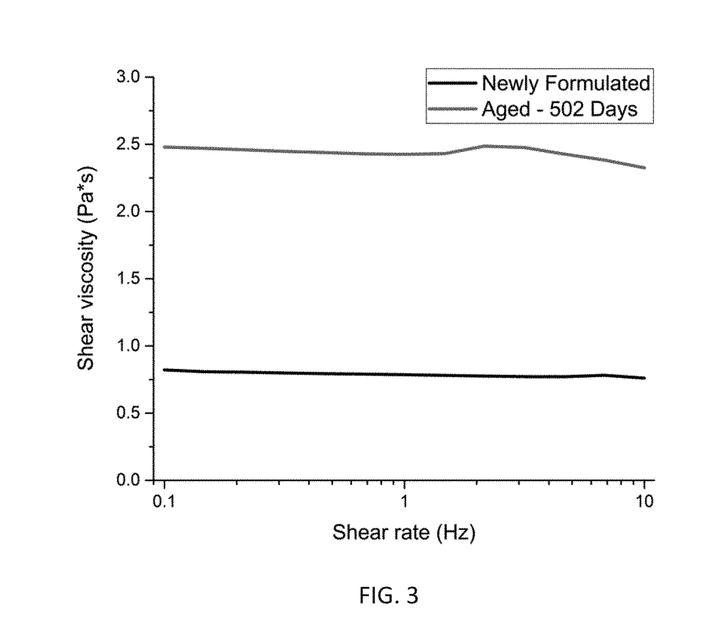

Both the first sample (now aged 502 days) and the second sample respectively were placed in a Malvern Kinexus pro+ rheometer with a Couette attachment and their viscosities measured at 25° C. and at varying shear rates. This testing took place on the date the second sample was made. The results can be seen in FIG. 3. FIG. 3 is a graph showing viscosity measurements of both a new sample (the second sample) and a sample that had aged for 502 days (the first sample). The plot shows that the aged sample has approximately three times the viscosity of the new sample, but the viscosity is low enough that the sample can be used to manufacture an article after storage for an extended period of time.

The compositions disclosed herein may be used in additive manufacturing (3D Printing). Stereolithography and inkjet printing may also be used to build up shapes out of liquid resin. In either of these processes the current invention could be used to first create the shape, as it cures under UV light, and then to frontally cure into a final article that may have increased mechanical properties. Other applications may include adhesives, coatings, the creation of gradient materials, and composites.

It is to be noted that all ranges detailed herein include the endpoints. Numerical values from different ranges are combinable.

The term “and/or” includes both “and” as well as “or.” For example, “A and/or B” is interpreted to include A, B, or A and B.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A composition comprising:
a first low molecular weight molecule that is radically polymerizable;
a second low molecular weight molecule that is ionically polymerizable; and
an initiator package that comprises a free radical initiator, an ionic accelerator and an ionic initiator; where the first low molecular weight molecule undergoes a radical polymerization reaction when subjected to a first form of activation stimuli and where the second low molecular weight molecule undergoes an ionic polymerization reaction in a spatially propagating reaction front or in a global reaction that occurs throughout the entire composition; where the ionic polymerization is initiated by a second form of activation stimuli.

2. The composition of claim 1, where the radical polymerization reaction and the ionic polymerization reaction are conducted sequentially.

3. The composition of claim 1, where the radical polymerization reaction proceeds prior to the ionic polymerization reaction.

4. The composition of claim 3, where the ionic polymerization reaction is a cationically polymerized reaction.

5. The composition of claim 1, where the ionic accelerator is a cationic accelerator that functions as a thermal radical generator.

6. The composition of claim 1, where the first low molecular weight molecule comprises a first plurality of chemically different low molecular weight molecules and where the second low molecular weight molecule comprises a second plurality of chemically different low molecular weight molecules.

7. The composition of claim 1, where the first low molecular weight molecule is an acrylate and is present in the composition in an amount of 1 to 50 wt %, based on a total weight of the composition.

8. The composition of claim 7, where the acrylate comprises trimethylpropane triacrylate present in an amount of 1 to 15 wt % and isobornyl acrylate present in an amount of 1 to 15 wt %, each based on a total weight of the composition.

9. The composition of claim 1, where the second low molecular weight molecule is an epoxy and is present in an amount of 40 to 99 wt %, based on a total weight of the composition.

10. The composition of claim 9, where the epoxy comprises 3,4-epoxycyclohexylmethyl 3,4-epoxycyclohexanecarboxylate present in an amount of 30 to 65 wt % and bisphenol A diglycidyl ether present in an amount of 20 to 45 wt %, each based on the total weight of the composition.

11. The composition of claim 1, where the initiator package comprises p-(octyloxyphenyl)phenyliodonium hexafluoroantimonate, 1,1,2,2-tetraphenyl-1,2-ethanediol and diphenyl(2,4,6 trimethylbenzoyl)phosphine oxide.

12. The composition of claim 1, where the first polymerization reaction produces a first polymer from the first low molecular weight molecule and where the second polymerization reaction produces a second polymer from the second low molecular weight molecule.

13. The composition of claim 12, where the first polymer and the second polymer are both crosslinked polymers and are in the form of an interpenetrating network.

14. The composition of claim 1, where a gelled composition is thermally stable for a period of at least 1 day after the radical polymerization is conducted, where thermally stable includes storage at 30° C. or less.

15. An article comprising the composition of claim 1.

16. A method of manufacturing an article comprising:
mixing together a composition comprising:
a first low molecular weight molecule that is radically polymerizable;
a second low molecular weight molecule that is ionically polymerizable; and
an initiator package that comprises a free radical initiator, an ionic accelerator and an ionic initiator;
subjecting the first low molecular weight molecule to a first form of activation stimuli;
polymerizing the first low molecular weight molecule via radical polymerization in a first polymerization reaction;
subjecting the second low molecular weight molecule to a second form of activation stimuli; and
polymerizing the second low molecular weight molecule via ionic polymerization in a second polymerization reaction.

17. The method of claim 16, where the first form of activation stimuli is UV radiation and where the second form of activation stimuli is contact with a heat source.

18. The method of claim 16, where the second form of activation stimuli is conducted at least 1 day after the first form of activation stimuli.

19. The method of claim 16, where the second form of activation stimuli is conducted at least 7 days after the first form of activation stimuli.

20. The method of claim 16, where the first form of activation stimuli and the second form of activation stimuli is a heat source.

21. The method of claim 16, where the ionic polymerization is cationic polymerization and where the ionic accelerator is a cationic accelerator.

22. The method of claim 16, further comprising:
disposing a first layer of the composition on a substrate;
conducting the first polymerization reaction of the first layer;
disposing a second layer of the composition atop the first layer;
conducting the first polymerization reaction of the second layer; and
conducting the second polymerization reaction of the first and second layers to bond the first layer to the second layer.
